(19) United States
(12) Patent Application Publication
(10) Pub. No.: US 2026/0201697 A1
(43) Pub. Date: Jul. 16, 2026

(54) RETENTION, DRAINAGE AND CULTIVATION BOARD, ITS PRODUCTION METHOD AND SYSTEM OF EQUIPMENT FOR ITS PRODUCTION

(71) Applicant: ARBOR - OKRASNE A OVOCNE SKOLKY, S.R.O., Senec (SK)

(72) Inventors: Dusan MARECEK, Skalica (SK); Juraj PLESNIK, Myjava (SK); Pavel SCHUDICH, Mosovce (SK)

(21) Appl. No.: 19/138,119

(22) PCT Filed: Dec. 18, 2023
(86) PCT No.: PCT/SK2023/050029

§ 371 Date: Jun. 12, 2025

(30) Foreign Application Priority Data
Dec. 21, 2022 (SK) 131-2022

(51) Int. Cl. E04C 2/52; A01G 9/033; A01G 20/20; A01G 24/20; A01G 24/30; A01G 24/44; B27N 3/00; B27N 3/04

(52) U.S. Cl. CPC E04C 2/526; A01G 9/033; A01G 20/20; A01G 24/20; A01G 24/30; A01G 24/44; B27N 3/002; B27N 3/007; B27N 3/04

(57) ABSTRACT

The retention, drainage and cultivation board according to the present invention comprises 80 to 85 vol. % of recycle from synthetic combined and composite fabrics in the form of tuft material and 20 to 15 vol. % of hardened polyurethane, and where the volume weight of the board is 150 to 250 kg/m3. The invention also relates to the manufacturing method of such board and to a set of equipment for carrying out the method.

### TECHNICAL FIELD

The invention relates to a retention, drainage and cultivation board suitable as a construction element for creation of retention areas, such as, e.g. extensive green roofs or facades, walkways and car parks. Furthermore, the invention relates to the production method of this board as well as to the equipment for its production.

### BACKGROUND ART

Currently, there is a growing demand for buildings with green roofs or green facades. An integral part of such roofs or facades is a substrate which usually consists of a layer of soil, a layer of special substrate with increased share of water-retaining minerals. A minimum substrate thickness of 50-100 mm is recommended for growing vegetation. However, at this thickness, the total surface density of the composition with the saturated substrate limits the size of the roof surface and increases the demands on the facade structure to be able to accommodate such loads. Thus, there is a requirement to reduce the load on the roof sheathing.

The solution is to replace a part of the substrate with another, lighter component. This component is expected to maintain the retention and drainage capacity of the original substrate as well as to allow the vegetation to take root, what means maintaining sufficient internal space for the root system and free air even when the board is fully saturated with water.

Today, such components are made from regularly deposited mineral or synthetic textile fibers. Their disadvantage is that they have a higher retention capacity than the original substrate. This means that although they allow vegetation to take root, due to high water retention in this component, there is a risk of waterlogging of the root system of the vegetation and its death.

Moreover, mineral and textile, regularly deposited fibre components lose their original retention capacity and dimensional stability under pressure. Therefore, they are not usable for permanently loaded areas. In the water-saturated state, at full retention, these components have limited manipulability, their destruction may occur. This limits their application in the rain.

Another shortcoming of the mineral and textile fibre components is that they cannot be separated from the soil substrate and vegetation at the end of the component's lifetime, what results in hazardous mixed waste. Also, at higher roof pitches their fixing is limited and requires additional auxiliary material, in case of vertical structures their use is almost excluded due to structural instability. Therefore, their use for green facades is basically excluded.

The requirement to reduce the roof sheathing load can also be met by lesser thickness of the roof substrate—soil. The reduced retention capacity of such substrate is addressed by a separate water retention liner, usually made of plastic. The latter is mainly in the form of nopes—cups—of different volumetric capacities. The disadvantage of such water retention liner is that it cannot perform a cultivation and limited drainage function.

### SUMMARY OF INVENTION

The aforementioned shortcomings are eliminated by the retention, drainage and cultivation board according to the present invention, which comprises 80 to 85 vol. % of recycle from synthetic combined and composite fabrics in the form of tuft material and 20 to 15 vol. % of hardened polyurethane, and where the volume weight of the board is 150 to 250 kg/m3 .

The tuft material consists of cuttings and/or shreds and/or fragments of the hardened fabric and non-textile particles which include dispersed, chaotically arranged and interwoven and intertwined fibers with each other and with particles, where these elements together form a cohesive assembly of a spatial-tuft structure with almost uniform distribution of these elements and where preferably at least one component of the assembly is a result of the recycling process of the worn-out and/or residual parts of the products used in the means of transport.

Such a tuft material can be produced, for example, as follows: the input material comprising hardened fabrics and combined textile-non-textile components, is first chopped on a chopping machine to the defined maximum chopped mass size. The chopped mass is then split, crushed, fragmented and torn up into tufts using a tufting machine. These tufts contain particles of input material surrounded by a clump of torn up fibres. The tufts are then mechanically modified into a coherent assembly of elements whose spatial structure approximates to uniform distribution of its elements.

Preferably, the tuft may also be made in the manner described in Patent No. SK288377B6, page 2, lines 38 to 48, Example 1 and claims 2 to 4.

A suitable tufting machine is described in Patent No. SK288377B6, page 2, line 49 to page 3, line 14, examples 2 and 3, and claims 5 to 10.

The tufts are preferably made up of several types of technical fabrics. Technical fabrics contain at least 80% synthetic fibres. Technical fabrics can be formed as purely fibrous formations (woven, non-woven) and further combined from several types of textile components and composite, where the textile component is complemented by a non-textile component.

The retention, drainage and cultivation board according to the present invention can partially or completely replace the soil substrate used for retention areas, such as extensive green roofs, wherein its surface density is 4-7 times lower than the soil substrate itself. The composition of the tuft board, clumps of original textile and non-textile parts, is very close to that of soil, a special substrate with an increased proportion of minerals that retain water where the function of water retention is performed by the tuft and the preservation of air space for the root system of the vegetation is performed by the interconnected protruding fibres of the tuft.

The tuft board also has a high drainage function, draining excess water that exceeds the retention capacity of the tuft. Therefore, preferably, the soil substrate layer can be reduced to 0-25 mm.

Advantages of the board according to the present invention, as a substitute for a substrate, are:
allows vegetation to take root thus significantly reducing or excluding the need for soil, special substrate
retention—water retention capacity of the board is up to 50 % of its volume thus fully replacing the capacity of the retained water for the substituted substrate
the rate of water absorption into the board is at least by 30 % higher than the one provided for by the original substrate
it also performs a drainage function, when maximum retention is reached, it ensures fluent drainage of excess water
at full retention—the capacity of retained water, sufficient air gaps are maintained for the root system of vegetation, what means almost zero risk of waterlogging—drowning of the roots
the board is characterized by high mechanical resistance to pressure, there is no damage to the board and its retention function neither in dry or saturated state
the board preserves sufficient retained water even when placed in a skew /d/ or vertical position, in at least 10 % of its volume

A new benefit of this board compared to the previous solution of components replacing the original substrate is that:
it allows grooves to be moulded to accommodate hose lines for additional water distribution
auxiliary anchoring elements, e.g. metal plates can be pressed into the board
has the ability to diffuse water from drip irrigation over the entire surface of the board
low diffusion resistance of the board structure allows active water capillarity—its gradual evaporation from the surface
the board allows mechanical and chemical anchoring to the substrate—wind resistance, applications for sloped roofs and vertical walls
80 and 85% of the board composition is made up of the material resulting from waste recovery
at the end of the board lifecycle the board can be separated from the substrate and vegetation part and reintroduced into the waste recovery process

Another aspect of the present invention is a manufacturing method of a retention, and cultivation board comprising the following steps:
a. recycle from synthetic combined and composite fabrics in the form of tuft material with bulk tuft material density in the range of 50 to 70 kg/m3 (preferably tuft material which is the subject to protection of patent No. SK288377B6) is mixed with water having the max. temperature of 15° C. in the amount from 15 to 25 kg of water per 1 m3 of bulk tuft material
b. the wet tuft material mixture is compacted to density of 100 to 120kg/m3, which is achieved by down pressure of a roller placed transversely over the belt on which the wet tuft material is moved
c. the mixture is mixed with the one-component polyurethane-based adhesive in the amount of 10 to 20 kg per 1 m3 of bulk tuft material until an essentially homogeneous mixture of the tuft material and adhesive is formed
d. the wet tuft material and adhesive mixture is compacted to density of 100 to 120kg/m3, which is achieved by down pressure of a roller placed transversely over the belt on which the wet tuft material with adhesive is moved
e. the mixture is evenly distributed into the mould and compressed with pressure that ensures 2.5 to 3.5 times compression of the mixture, i.e. the pressure on the piston of the upper part of the mould with a dimension of 1,200 mm×600 mm reaches pressure of 6-10 atm. This compression will result in a final mixture density of 200-250 kg/m3
f. the mixture will be taken out from the mould only after the adhesive has set completely. At least, the reaction time of the adhesive must be observed. The state of setting of the adhesive is confirmed by the fact that after taking out of the pressed mixture from the mould, the dimension of the board according to the mould is maintained.

According to a preferred embodiment, prior to step a), the tuft material is mixed to final bulk tuft material density in the range from 50 to 70kg/m3.

According to a preferred embodiment, a stock of mixed tuft material will be formed advance which will be stored in the storage chamber and subsequently steps (a) to (f) carried out.

According to a preferred embodiment, step (a) is carried out by regular distribution of the tuft material over the travelling belt and water is sprayed from above onto the spread out moving tuft material.

According to a preferred embodiment, in step c) the mixture is mixed using a planetary mixer. Also, between steps d) and e) the mixture may be mixed, preferably using a planetary mixer.

The production preferably takes place on a travelling belt.

Tufts of different types of fabrics are mixed to produce a mixture containing variously distributed and intertwined individual tufts, wherein the resulting bulk tuft material density falls within the range from 50 to 70kg/m3. Mixing may be carried out in a device for mixing textile mixtures, where groups of smaller diameter cylinders are rotated in the opposite direction around the main rotating cylinder. A stirred tuft mixture may first be deposited in a storage chamber, and then the mixture is spread on a travelling belt. Cold water (up to 15° C.) is sprayed into the tuft mixture in the amount of approx. 15-25 kg per 1 m3 of tufts. A tuft mixture with water advances on the belt under the roller, which compresses it, the down pressure force of the roller must ensure compaction of the tuft mixture to the density of 100-125 kg/m3. In the next progression of the mixture, one-component polyurethane-based adhesive is added in the amount of 10-20 kg per 1 m3 of bulk tuft mixture. The mixture is then mixed using a planetary mixer. The stirred tuft mixture with adhesive proceeds on the belt under the roller, which compresses it, the down pressure force of the roller must ensure compaction of the tuft mixture to the density of 100-120 kg/m3. The tuft mixture can be stirred using a planetary mixer. The mixture is taken, weighed in the quantity determined by the size of the mould for the product. Preferably, the mixture is dispensed directly from the belt into a mould which is placed on a scale. The weighed mixture is evenly distributed over the entire surface of the mould and at a uniform height. The decomposed mixture is enclosed in the mould in the shape of a product, usually a board, and compressed with the pressure that ensures 2.5-3.5 times compression of the decomposed mixture. The mould is opened only after the adhesive has completely set.

According to a preferred embodiment, the setting time of the adhesive can be accelerated by spraying water at a temperature of 65° C. to 85° C. into the spread mixture before closing the mould and pressing in the amount of 15-25 kg per 1 m3 of the mixture.

According to an advantageous embodiment, before placing the mixture in the mould and/or after its spreading in the mould, a hoof is also inserted into the mould to form a moulded shape in the board, e.g. to form a groove for guiding a water distribution hose, metal anchoring plates, etc.

Another aspect of the present invention is a set of equipment for carrying out a method according to the present invention. The set of equipment includes:
preferably a storage chamber for the stirred tuft mixture
a continuous belt with travelling speed control
a cold water dosing device; preferably consisting of a set of nozzles providing water spraying in the width of the belt
the first pressure roller; the diameter of the pressure roller is usually 1/3 of the belt width. The cylinder pressure is generated by its weight and/or another pressure regulator
a polyurethane-based adhesive dosing device; Preferably consisting of a set of outlet tubes in the entire belt width. The adhesive is extruded through a dosing pump from the adhesive reservoir. The outlet part of the dosing device is made of replaceable and sealable components
the first planetary mixer; The planetary mixer preferably comprises two rotating plates in a horizontal plane above a travelling belt, wherein each plate preferably intervenes in the mixture via two to four rod-shaped stirrers perpendicularly mounted to the plane of the rotating plate
the second pressure roller; Preferably of the same design as the first pressure roller
the second planetary mixer; Preferably the same design as the first planetary mixer
a press mould and a dosing device, preferably in the form of a scale
a pressing device, preferably a piston press with a pusher

### EXAMPLES

### Example 1

A board designed for green roofs with water distribution, green facades.

The input raw material is made up of tuft material from various residual technical fabrics in approximately the same proportion as they are represented in the structure of a new car (interior and exterior, combined and composite fabrics). Tufts from this mixture of fabrics were intermixed. Their bulk weight was 60 kg/m3. The board was formed by wetting the mixture with water, 20 1 per 1 m3 of mixture. A polyurethane-based adhesive was added to the wet tuft mixture at a rate of 20% by weight of adhesive to 80% by weight of the dry tuft mixture. After mixing this wetted tuft mixture with the added adhesive, the appropriate amount was weighed and layered in the mould. Prior to closing the mould and its pressing, a liner was inserted on the surface of the spread mixture to form an impression of the distribution channels to accommodate the drip irrigation hoses. The surface of the spread mixture was sprayed with water in the amount of 20 1 per 1 m3 of the mixture at a temperature of 65° C. The mould was closed and pressurised applying the pressure of 6-8 atm, which increased the density of the spread mixture 2.6 times to the final bulk density of 200 kg/m3. The thickness of the board was determined to 50 mm. After the adhesive has fully reacted, the board is taken out from the mould.

Such a board complies with the technical regulations in terms of parameters and it is suitable for application as an extensive green roof with water distribution or an active green wall with water flowing from the top edge of the wall. Free pores in the structure of the pressed tuft board allow water retention up to the total amount of 50% from the total volume of the board. Even in case of full absorption of water into the board, there is still enough of free space for air in the board (almost 30% of the board volume). This allows the board to be uprooted by vegetation and to prevent the root system from becoming waterlogged.

To implement the vegetation, the board is saturated with water to its full capacity, when it accepts no more water, vegetation cuttings of the SEDUM genus are spread and can be covered with a layer of soil substrate designed for green roofs and/or with crushed gravel. The vegetation roots into the board within 2-4 months.

### Example 2

Board designed for retention, load and other areas.

The input raw material is made up of tuft material from various residual technical fabrics in approximately the same proportion as they are represented in the structure of a new car (interior and exterior, combined and composite fabrics). Tufts from this mixture of fabrics were intermixed. Their bulk weight was determined to 60kg/m3. The board was formed by wetting the mixture with water, 20 1 per 1 m3 of mixture. A polyurethane-based adhesive was added to the wet tuft mixture at a rate of 15% by weight of adhesive to 85% by weight of the dry tuft mixture. After mixing this wetted tuft mixture with the added adhesive, the appropriate amount was weighed and layered in the mould. Before placing the mixture in the mould and its pressing, metal plates were inserted into the bottom of the mould. The surface of the spread mixture was sprayed with water in the amount of 20 1 per 1 m3 of the mixture at a temperature of 65° C. The mould was closed and pressurised applying the pressure of 8-10 atm, which increased the density of the spread mixture 3.3 times to the final bulk density of 250 kg per 1 m3 of the mixture. The thickness of the board was determined to 50 mm. After the adhesive has fully reacted, the board was taken out from the mould.

Such board complies with the technical regulations in terms of parameters and it is suitable for application to the areas with water retention and the ability to evaporate water from the surface. Free pores in the structure of the pressed tuft board allow water retention up to the total amount of 50% from the total volume of the board. Even in case of full absorption of water into the board, there is still enough of free space for air in the board (almost 30% of the board volume). This allows the board to be uprooted by vegetation and to prevent the root system from becoming waterlogged.

To implement the vegetation, the board is saturated with water to its full capacity, when it accepts no more water, vegetation cuttings of the SEDUM genus are spread and can be covered with a layer of soil substrate designed for green roofs and/or with crushed gravel. The vegetation roots into the board within 2-4 months.

1. A retention, drainage and cultivation board, characterized in that 80 to 85% of its volume is made up of synthetic combined and composite fabric recycle in the form of tuft and 20 to 15% of its volume is made up of hardened polyurethane, and where the bulk density of the board is 150 to 250 kg/m3.

2. The board according to claim 1, characterized in that the tuft material is tuft material comprising cuttings and/or shreds and/or fragments of the hardened textile and non-textile particles which include dispersed, chaotically arranged and interwoven and intertwined fibers with each other and with particles, where these elements together form a cohesive assembly of a spatial-tuft structure with almost uniform distribution of these elements.

3. The board according to claim 2, characterized in that at least one component of the tuft is a result of the recycling process of worn and/or residual parts of the products used in the means of transport.

4. A manufacturing method of a retention, drainage and cultivation board according to any one of the claims 1 to 3, characterized in that it comprises the steps of:
a. the recycle from synthetic combined and composite fabrics in the form of tuft material having a bulk tuft material density in the range from 50 to 70 kg/m3 shall be mixed with water having max. temperature of 15° C. in the amount from 15 to 25 kg of water per 1 m3 of tuft material
b. the mixture of wet tuft material is compacted to the density of 100 to 120 kg/m3, preferably by rolling,
c. the mixture is mixed with the one-component polyurethane-based adhesive in the amount of 10 to 20 kg of adhesive per 1 m3 of bulk tuft material until an essentially homogeneous mixture of the tuft material and adhesive is formed
d. the mixture of wet tuft material and adhesive is compacted to the density of 100 to 120 kg/m3, preferably by rolling,
e. the mixture is evenly distributed in the mould and compressed applying the pressure that ensures 2.5 to 3.5 times compression of the mixture to the density of 200 to 250kg/m3,
f. the mixture will be taken out from the mould only after the adhesive has set completely.

5. According to claim 4, characterized in that prior to step a), the tuft material is mixed to achieve a final bulk tuft material density in the range from 50 to 70 kg/m3.

6. According to claim 5, characterized in that a stock of mixed tuft material will be formed which will be stored in the storage chamber and subsequently steps (a) to (f) are carried out.

7. According to claim 5 or 6, characterized in that step a) is carried out by regular distribution of the tuft material over the travelling belt and water is sprayed from above onto the spread out moving tuft material.

8. Method according to any of claims 4 to 7, characterized in that in step c) the mixture is stirred using a planetary mixer.

9. Method according to claim 5 or 6, characterized in that between steps d) and e) the mixture is stirred, preferably using a planetary mixer.

10. Method according to any of claims 4 to 9, characterized in that in step e) water at a temperature of 65° C. to 85° C. is sprayed into the spread mixture prior to closing the mould, in the amount of 15 to 25 kg per 1 m3 of mixture.

11. Method according to any of claims 4 to 10, characterized in that in step e), before and/or after inserting the mixture into the mould, a liner is inserted into the mould to form the moulded shape or anchoring.

12. A system of devices for carrying out the method according to any of claims 4 to 11, characterized in that it comprises a continuous travelling belt capable of controlling the travel rate above which the following devices are arranged, in the mentioned order: a cold water dispensing device; a first pressure roller; a polyurethane-based adhesive dispensing device; a first planetary mixer; a second pressure roller; and a second planetary mixer, where behind the continuous travelling belt a compound dispensing device, a compression mold, and a pressing device are positioned.

13. A system according to claim 12, characterized in that the dispensing device for the mixture is a scale.

14. A system according to claim 12 or 13, characterized in that the pressing device is a piston press.

15. A system according to any of claims 12 to 14, characterized in that a hot water dispensing device is placed between the dispensing device and the pressing device.
